(19) United States
(12) Patent Application Publication
(10) Pub. No.: US 2026/0370068 A1
(43) Pub. Date: Nov. 19, 2026

(54) SINGLE-PHASE PERMANENT MAGNET MOTOR AND HOUSEHOLD APPLIANCE

(71) Applicants: Jiaxipera Compressor Co., Ltd., Jiaxing (CN); ZHEJIANG UNIVERSITY, Hangzhou (CN)

(72) Inventors: Huijun Yao, Jiaxing (CN); Zhenyang Zhang, Hangzhou (CN); Wenzhi Wang, Jiaxing (CN); Baimei Yang, Jiaxing (CN); Lijian Wu, Hangzhou (CN); Yu Xia, Hangzhou (CN)

(73) Assignees: Jiaxipera Compressor Co.,Ltd., Jiaxing (CN); ZHEJIANG UNIVERSITY, Hangzhou (CN)

(21) Appl. No.: 19/564,158

(22) Filed: Mar. 11, 2026

(30) Foreign Application Priority Data
Mar. 12, 2025 (CN) 2025102876672
Mar. 6, 2026 (CN) 2026102692264

(51) Int. Cl. H02K 1/16; H02K 1/276; H02K 11/215

(52) U.S. Cl. CPC H02K 1/165; H02K 1/276; H02K 11/215; H02K 2213/03

(57) ABSTRACT

A single-phase permanent magnet motor and a household appliance are provided. The single-phase permanent magnet motor comprise a rotor core and a stator core, and the rotor core and the stator core are coaxially arranged. At least two stator teeth are correspondingly arranged on an inner side of the stator core, with coils wound around the stator teeth, and the coils are connected in series. A starting slot is provided at an end of a stator tooth away from a yoke, the starting slot being located on a side of the stator tooth opposite to a rotor rotation direction along a centerline of the tooth, wherein a central angle corresponding to an interval between an edge of the starting slot and an adjacent slot opening is less than a predetermined angle, and the slot opening is located between two adjacent stator teeth.

### SINGLE-PHASE PERMANENT MAGNET MOTOR AND HOUSEHOLD APPLIANCES

The present application claims the priority of Chinese patent applications 2025102876672 filed on Mar. 12, 2025, and 2026102692264 filed on Mar. 6, 2026. The contents of the Chinese patent applications are incorporated herein by reference in their entireties.

### TECHNICAL FIELD

The The present disclosure relates to the field of motor technology, and specifically to a single-phase permanent magnet motor and household appliances.

### BACKGROUND

Single-phase permanent magnet synchronous motors have advantages such as simple structure, small size, light weight, and high efficiency, and have been widely used in the field of low-power household appliances. At present, single-phase permanent magnet motors in the field of household appliances are mainly fixed-frequency self-starting single-phase permanent magnet motors and variable-frequency single-phase DC brushless permanent magnet motors. The fixed-frequency self-starting single-phase permanent magnet motor is directly powered by a single-phase AC power supply, with the stator having two sets of windings including a main winding and an auxiliary winding, and the rotor is a permanent magnet rotor with a starting winding, which requires a series capacitor for operation. The variable-frequency single-phase DC brushless permanent magnet motor has a stator with only one set of windings, and a permanent magnet rotor, and is usually powered by a grid voltage converted through a rectifier-inverter.

For the fixed-frequency self-starting single-phase permanent magnet motor, although it has self-starting capability and no controller loss, it can only operate in a single power frequency mode, unable to dynamically adjust to multiple operating conditions of household appliances, resulting in high operating power consumption. For the variable-frequency single-phase DC brushless permanent magnet motor, although it is controlled by a frequency converter and can adjust the operating frequency based on the actual operating conditions of household appliances, it cannot directly use grid power for grid-connected operation, and the loss of the controller will significantly reduce the efficiency of the motor system. Moreover, due to the inherent “starting dead point” characteristic of single-phase permanent magnet motors, there is a problem that they cannot start at the dead point position (where the centerline of the magnetic pole coincides with the centerline of the stator tooth).

### SUMMARY

The present disclosure aims at the problem that single-phase permanent magnet motors in the prior art cannot self-start due to the existence of dead point, and intends to provide a single-phase permanent magnet motor and a household appliance.

In one aspect, the present disclosure provides a single-phase permanent magnet motor, comprising: a rotor core and a stator core, wherein the rotor core and the stator core are coaxially arranged; at least two stator teeth correspondingly arranged on an inner side of the stator core, with coils wound around the stator teeth and the coils being connected in series; and a starting slot provided at an end of a stator tooth away from a yoke, the starting slot being located on a side of the stator tooth opposite to a rotor rotation direction along a centerline of the tooth, wherein a central angle corresponding to an interval between an edge of the starting slot and an adjacent slot opening is less than a predetermined angle, and the slot opening is located between two adjacent stator teeth.

Alternatively, the rotor core is provided with a permanent magnet, and at least one damper bar is inserted through the rotor core in a predetermined region, the predetermined region being located between the permanent magnet and an air gap, wherein the air gap is located between the stator core and the rotor core, and the damper bar is configured to cut a magnetic field to generate a reaction force for suppressing a speed variation of the rotor.

Alternatively, each stator tooth, at its end remote from the yoke, extends circumferentially to both sides about the centerline of the tooth to form symmetric tooth shoes.

Alternatively, a sheet-shaped permanent magnet is inserted through the rotor core, and a central angle corresponding to a width of a flux bridge on a side edge of the permanent magnet adjacent to the air gap is the predetermined angle.

Alternatively, each axial end face of the rotor core is respectively provided an end ring at an edge thereof, the damper bar is electrically connected via the end ring, and the permanent magnet is fixed in the rotor core by two end rings.

Alternatively, the number of poles of the permanent magnet, the number of stator teeth, and the number of damper bars are all even numbers.

Alternatively, a cross-section of the damper bar is circular or polygonal.

Alternatively, a cross-sectional shape of the permanent magnet is any one of a tile shape, an in-line shape, and a V-shape.

Alternatively, a material of the damper bar comprises copper and/or aluminum.

Alternatively, the stator teeth are evenly distributed along a circumference of the stator core, and permanent magnets are evenly distributed along a circumference of the rotor core.

Alternatively, the permanent magnet is magnetized by parallel magnetization or radial magnetization.

Alternatively, the predetermined region is located on an arc concentric with the rotor core.

Alternatively, endpoints of the arc are respectively connected to an end of the permanent magnet away from the starting slot and a first connecting line, the first connecting line being a line connecting an endpoint of the starting slot, which is on a side edge of the starting slot closer to the centerline of the tooth and closer to the air gap, and a midpoint of the permanent magnet, when the centerline of the stator tooth coincides with the centerline of the permanent magnet, wherein the midpoint is an intersection point of a contour line of the permanent magnet on a side close to the damper bar and the centreline of the permanent magnet.

Alternatively, the predetermined region is an intersection point of the arc and a second connecting line, the second connecting line being a line connecting an endpoint of the tooth shoe away from the starting slot and closer to the centerline of the tooth, and the midpoint of the permanent magnet, when the centerline of the stator tooth coincides with the centerline of the permanent magnet, wherein the midpoint is the intersection point of the contour line of the permanent magnet on the side close to the damper bar and the centerline of the permanent magnet.

In another aspect, the present disclosure provides a single-phase permanent magnet motor, comprising: a rotor core and a stator core, wherein the rotor core and the stator core are coaxially arranged, at least two stator teeth are correspondingly arranged on an inner side of the stator core, with coils wound around the stator teeth, the coils are connected in series, the rotor core is provided with a permanent magnet, and at least one damper bar is inserted through the rotor core in a predetermined region, wherein the predetermined region is located between the permanent magnet and an air gap, wherein the air gap is located between the stator core and the rotor core, and the damper bar is configured to cut a magnetic field to generate a reaction force for suppressing a speed variation of the rotor.

Alternatively, each axial end face of the rotor core is respectively provided an end ring at an edge thereof, the damper bar is electrically connected via the end ring, and the permanent magnet is fixed in the rotor core by two end rings.

Alternatively, the number of poles of the permanent magnet and the number of damper bars are both even numbers.

Alternatively, a cross-sectional shape of the permanent magnet is any one of a tile shape, a straight shape, and a V-shape.

Alternatively, a cross-section of the damper bar is circular or polygonal.

Alternatively, a material of the damper bar comprises copper and/or aluminum.

Alternatively, the predetermined region is located on an arc concentric with the rotor core.

In yet another apsect, the present disclosure provides a household appliance, comprising the above mentioned single-phase permanent magnet motor.

### BRIEF DESCRIPTION OF THE DRAWINGS

FIG. 1 illustrates a schematic structural diagram of a single-phase permanent magnet motor according to an exemplary embodiment of the present disclosure.

FIG. 2 illustrates a schematic diagram illustrating a central angle corresponding to an interval between an edge of a starting slot and an adjacent slot opening according to an exemplary embodiment of the present disclosure.

FIG. 3 illustrates a schematic diagram of flux bridges according to an exemplary embodiment of the present disclosure.

FIG. 4 illustrates a waveform diagram of cogging torque with and without a starting slot and at different a positions according to an exemplary embodiment of the present disclosure.

FIG. 5 illustrates a schematic diagram of damper bars according to an exemplary embodiment of the present disclosure.

FIG. 6 illustrates a schematic diagram of an end ring according to an exemplary embodiment of the present disclosure.

FIG. 7 illustrates a schematic diagram of a predetermined region according to an exemplary embodiment of the present disclosure.

FIG. 8 illustrates a waveform diagram illustrating grid-connected speed convergence with no damper bar and with damper bars at different positions according to an exemplary embodiment of the present disclosure.

FIG. 9 illustrates a schematic structural diagram of a rotor of a single-phase permanent magnet motor according to an exemplary embodiment of the present disclosure.

### DETAILED DESCRIPTION OF THE PREFERRED EMBODIMENT

The present disclosure is further explained below through embodiments, but it is not limited to the scope of the described embodiments.

In the embodiments of the present disclosure, prefixes such as “first” and “second” are used merely to distinguish different described objects, and do not limit the position, sequence, priority, quantity, or content of the described objects. The use of ordinal numbers or other prefixes to distinguish described objects in the embodiments of the present disclosure does not constitute a limitation on the described objects. The description of the described objects refers to the claims or the context in the embodiments, and should not be construed as redundant limitations due to the use of such prefixes. Furthermore, in the description of this embodiment, unless otherwise specified, “a plurality” means two or more.

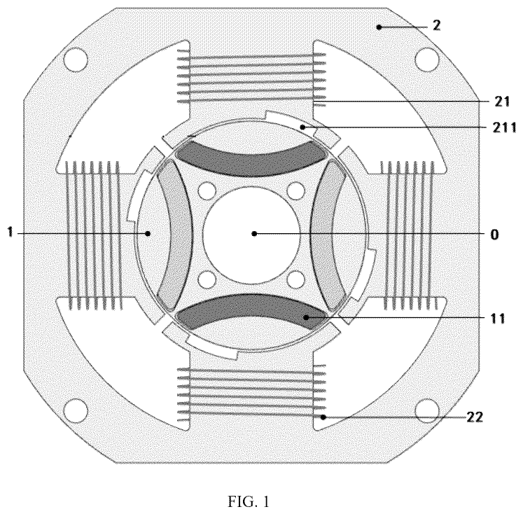

FIG. 1 is a schematic structural diagram of a single-phase permanent magnet motor according to an exemplary embodiment of the present disclosure. The single-phase permanent magnet motor includes a rotor core 1 and a stator core 2, and the rotor core and the stator core are coaxially arranged.

In an alternative embodiment, the stator core is formed by laminating silicon steel sheets, and the rotor core comprises a built-in permanent magnet.

At least two stator teeth 21 are correspondingly arranged on an inner side of the stator core 2, with coils 22 wound around the stator teeth 21, and the coils 22 are connected in series.

In an alternative embodiment, the number of stator teeth of the motor is equal to the number of rotor poles and is an even number.

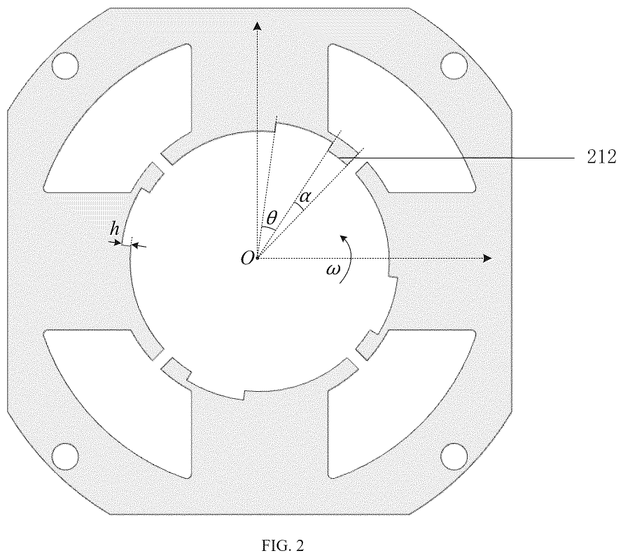

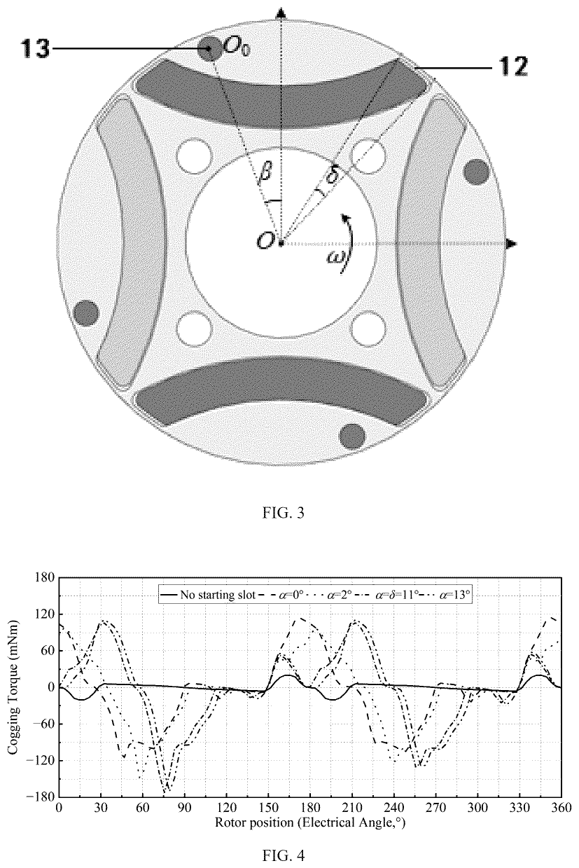

Referring to FIG. 2 and FIG. 3, a starting slot 211 is provided at an end of the stator tooth 21 away from the yoke, the starting slot being located on a side of the stator tooth opposite to the rotor rotation direction along the centerline of the tooth. A central angle a corresponding to an interval 212 between an edge of the starting slot and an adjacent slot opening is less than a predetermined angle δ, and the slot opening is located between two adjacent stator teeth.

In an alternative embodiment, referring to FIG. 2, a maximum central angle corresponding to edge contour lines of the starting slot (with the center at the rotor center O) is θ, where θ+α<π/M, where M is the number of stator teeth.

In an alternative embodiment, each stator tooth, at its end remote from the yoke, extends circumferentially to both sides symmetrically about the centerline of the tooth to form symmetric tooth shoes, and a portion of the starting slot is formed in a tooth shoe.

In an alternative embodiment, the starting slot may be tile-shaped, rectangular, crescent-shaped, etc.

In an alternative embodiment, α satisfies 0<α<δ, because when α≥δ, the motor cannot self-start. Referring to FIG. 4, when the rotor is at the initial position, i.e., when the centerline of the stator tooth coincides with the centerline of the permanent magnet, the cogging torque is zero. At this time, the no-load back EMF is zero. Even if the coil is energized, the electromagnetic torque is zero, so the combined torque of cogging torque and electromagnetic torque is zero, and the rotor cannot rotate, meaning that the motor cannot self-start at this point.

In an alternative embodiment, sheet-shaped permanent magnets 11 are inserted through the rotor core. Referring to FIG. 3, a central angle δ corresponding to a width of a flux bridge 12 on a side edge of the permanent magnet adjacent to the air gap is the predetermined angle.

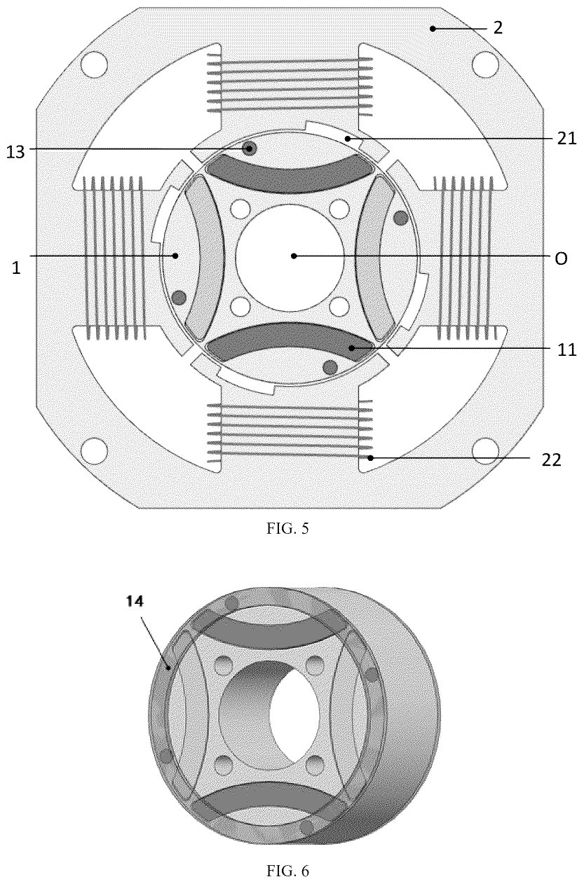

In an alternative embodiment, referring to FIG. 5, the rotor core is provided with permanent magnets 11, and at least one damper bar 13 is inserted through the rotor core in a predetermined region. The predetermined region is located between the permanent magnet and an air gap which is located between the stator core and the rotor core. The damper bar is configured to cut a magnetic field to generate a reaction force for suppressing a speed variation of the rotor. The main function of the damper bar is that when the single-phase permanent magnet motor operates by directly connecting to the grid, there is no controller, and the motor may experience speed divergence due to underdamping. Since the rotor speed is not synchronized with the synchronous speed, the damper bar will cut the magnetic field to generate resistance, increasing the damping effect and reducing the speed. Therefore, the defect of grid-connected speed divergence existing in the prior art when single-phase permanent magnet motors are directly powered by the grid is overcome.

In an alternative embodiment, the damper bars may be arranged in a single bar arrangement or a multiple bar arrangement. The single bar arrangement is preferred as it exhibits a faster speed convergence compared to the multiple bar arrangement. When the centerline of the rotor magnetic pole aligns with the centerline of the stator tooth, arranging the damper bars on the rotor core side opposite to the starting slot provides better speed convergence performance, and there exist preferred regions or positions for the bar arrangement.

In an alternative embodiment, referring to FIG. 6, end rings 14 are respectively arranged at the edges of the axial end faces of the rotor core. The damper bars are electrically connected via the end rings, and the permanent magnets are fixed in the rotor core by the two end rings. The end rings can serve as rotor pressure plates, thereby eliminating the material cost and tooling cost of the stainless steel rotor pressure plates used in conventional motor rotors.

In an alternative embodiment, the number of poles of the permanent magnets, the number of stator teeth, and the number of damper bars are all even numbers, which may be two, four, or more. Each pole may include one or more permanent magnets, and each stator tooth is provided with one starting slot. The above numerical values are merely indicative of preferred embodiments and are merely illustrative. Those skilled in the art may make various changes or modifications to these numerical values without departing from the spirit and essence of the present disclosure, and such changes and modifications shall fall within the scope of the present disclosure.

In an alternative embodiment, the cross-section of the damper bar is circular or polygonal.

In an alternative embodiment, the cross-sectional shape of the permanent magnet is any one of a tile shape, an in-line shape, and a V shape.

In an alternative embodiment, the material of the damper bar may include high-conductivity materials such as copper, aluminum, etc.

In an alternative embodiment, the stator teeth are evenly distributed along the circumference of the stator core, and the permanent magnets are evenly distributed along the circumference of the rotor core.

In an alternative embodiment, the permanent magnet is magnetized by parallel magnetization or radial magnetization.

In an alternative embodiment, referring to FIG. 7, the predetermined region is located on an arc concentric with the rotor core.

In an alternative embodiment, referring to FIG. 7, the endpoints of the arc are respectively connected to an end of the permanent magnet away from the starting slot and a first connecting line (BC). The first connecting line is a line connecting an endpoint C of the starting slot, which is on the side edge of the starting slot closer to the centerline of the tooth and closer to the air gap, and a midpoint B of the permanent magnet, when the stator tooth centerline coincides with the permanent magnet centerline. The midpoint is the intersection point of the contour line of the permanent magnet on the side close to the damper bar and the centerline of the permanent magnet.

In an alternative embodiment, referring to FIG. 7, the predetermined region is the intersection point of the arc and a second connecting line (AB). The second connecting line is a line connecting an endpoint A of the tooth shoe away from the starting slot, the endpoint A being on the side of the tooth shoe closer to the centerline of the tooth, and the midpoint B of the permanent magnet, when the stator tooth centerline coincides with the permanent magnet centerline. The midpoint is the intersection point of the contour line of the permanent magnet one the side close to the damper bar and the centerline of the permanent magnet centerline.

In an alternative embodiment, the stator core is formed by laminating silicon steel sheets and comprises 4 stator teeth. Each stator tooth is wound with a coil having 569 turns, and the 4 coils are connected in series to form one phase winding. Referring to FIG. 2, a tile-shaped starting slot is formed on the pole shoe on the side of each stator tooth opposite to the rotation direction (the rotor rotation direction being indicated by an arrow labeled ω in the figure) along the centerline of the tooth. The central angle θ corresponding to the starting slot is 30°, and the depth h of the starting slot is 2 mm. The starting slot is not in communication with the slot opening, and the central angle α corresponding to the minimum width of the stator tooth pole shoe remaining therebetween is 2°. The above numerical values are merely intended to illustrate a preferred embodiment and are provided by way of example only. Those skilled in the art may make various changes or modifications to these numerical values without departing from the spirit and essence of the present disclosure, and such changes and modifications shall fall within the scope of the present disclosure.

Referring to FIG. 3, 4-pole permanent magnets are embedded in the rotor core. The permanent magnets are tile-shaped and radially magnetized. The central angle δ corresponding to the width of the flux bridge on the side edge of the magnetic pole adjacent to the air gap is about 11°. A single circular aluminum damper bar with a diameter of 3 mm is placed in the rotor core between each permanent magnet pole and the air gap. The angle β between the line OOₒ (connecting the center Oₒ of the damper bar and the rotor center O) and the centerline of the magnetic pole is about 18.7° (the positive and negative values of β indicate whether OOₒ leads or lags the centerline of the corresponding magnetic pole in the rotation direction). The damper bars for each pole are connected via an aluminum end ring structure. The above numerical values are merely intended to illustrate a preferred embodiment and are provided by way of example only. Those skilled in the art may make various changes or modifications to these numerical values without departing from the spirit and essence of the present disclosure, and such changes and modifications shall fall within the scope of the present disclosure.

FIG. 4 shows a comparison of cogging torque with and without a starting slot and at different α positions (with the single damper bar arrangement and β=18.7°) . It can be seen that when α≥δ or without a starting slot, the cogging torque at the position where the centerline of the magnetic pole coincides with the centerline of the stator tooth, i.e., the dead point position (the initial position of the rotor), is 0. Meanwhile, the no-load back EMF crosses zero at this position, and the electromagnetic torque is also 0, so that the combined torque at this position is 0 and the motor does not have self-starting capability. When a starting slot is present and α<δ, a relatively large cogging torque can be generated at the position where the centerline of the magnetic pole coincides with the centerline of the stator tooth, enabling self-starting. It is preferred that the starting slot and the slot opening are not in communication with each other, i.e., α>0, to ensure a sufficient phase difference between the zero-crossing point of the cogging torque and the zero point of the back EMF, facilitating position control for the motor.

FIG. 7 shows a schematic diagram of a preferred arrangement region for the damper bar when the centerline of the rotor magnetic pole aligns with the centerline of the stator tooth. In the figure, A is the endpoint of the stator tooth away from the yoke, and this endpoint is away from the starting slot; B is the midpoint of the permanent magnet on the side close to the damper bar; and C is the endpoint of the starting slot on the side edge thereof close to the centerline of the tooth. The arc on which the center point Oₒ of the cross-section of the damper bar lies (with the rotor center O as its center) intersects the line segments BA and BC at points O₂ (where β=18.7°) and O₃ (where β=−8°), respectively. Points O₁ (β=23°) and O₄ (β=−23°) are the lateral limit positions for the damp bar arrangement, considering mechanical strength constraints.

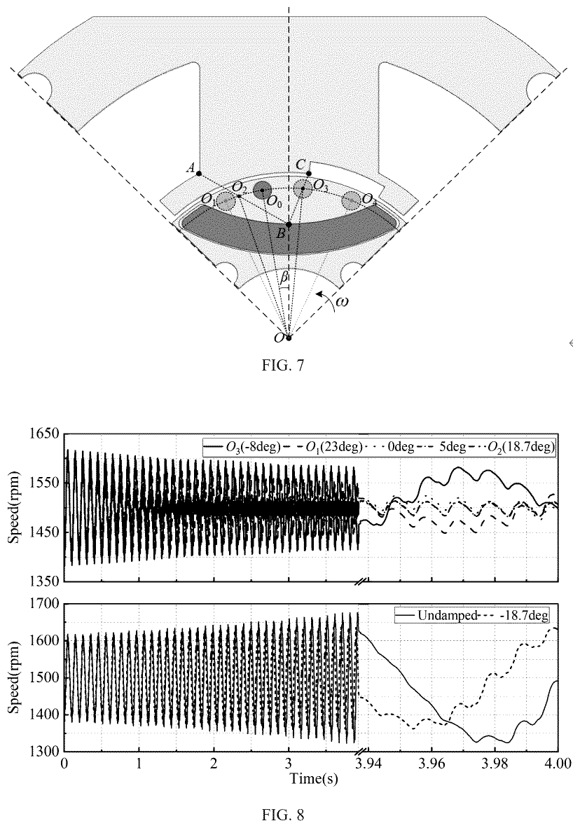

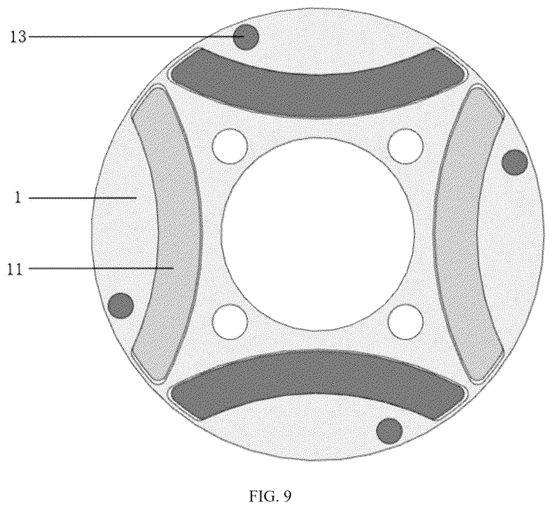

Taking a single bar arrangement as an example, FIG. 8 shows the grid-connected speed convergence with no damper bar and with damper bars at different positions, illustrating that the damper bar can effectively suppress grid-connected speed divergence, and there exists an optimal region or position for bar arrangement. From the comparison of speed convergence rates at different positions of the damper bar, it can be seen that when Oₒ is on the arc segment O₁O₂, and when Oₒ is near O₂ (18.7°), the damping effect of the damper bar is better, with small waveform fluctuation and fast speed convergence. If Oₒ moves from O₂ towards O₁, the damping effect deteriorates. Comparing the waveform at O₁ (23°) with that at O₂ (18.7°), where the former shows significantly larger fluctuation, it can be obtained that when Oₒ moves from O₂ to O₁, the rotor speed convergence rate decreases. When Oₒ is on the arc segment O₂O₃, if Oₒ moves from O₂ towards O₃, the damping effect of the damper bar deteriorates. Comparing the waveform at O₃ (−8°) with that at O₂ (18.7°), where the former shows significantly larger fluctuation, it can be obtained that the rotor speed convergence rate decreases, and the damping effect is even worse than that when Oₒ is near O₁ (23°). When Oₒ is on the arc segment O₃O₄, the damping effect of the damper bar is even poorer, and it may even fail to suppress speed convergence. It can be seen from the waveform when the damper bar is at −18.7° that the waveform is close to that without a damper bar, almost having no effect on suppressing speed convergence. Comparing the speed convergence when Oₒ is at position O₂ with that without damping, it can be seen that the damper bar effectively suppresses the problem of speed divergence. Furthermore, it can be inferred that when multiple bar arrangement is used, the damper bars should preferably be arranged towards the O₂ side.

The present disclosure provides a starting slot on a stator tooth, where the starting slot is arranged on a side of the stator tooth opposite to rotor rotation direction along the centerline of the tooth, and a central angle corresponding to an interval between an edge of the starting slot and a slot opening is less than a predetermined angle, which results in a cogging torque greater than zero when the rotor is at the initial position, thereby causing the rotor position to shift and avoid the starting dead point, thus generating an electromagnetic torque to drive the rotor to rotate after the coil is energized, overcoming the defect in the prior art that single-phase permanent magnet motors cannot self-start due to the existence of the dead point. The arrangement of the damper bar can effectively suppress the possible non-convergence of grid-connected speed, overcoming the defect of grid-connected speed divergence in the prior art when single-phase permanent magnet motors are directly powered by the grid, thereby enabling the single-phase motor to realize grid-connected operation and improve its operation efficiency.

An exemplary embodiment of the present disclosure provides a single-phase permanent magnet motor, comprising a rotor core 1 and a stator core, and the rotor core and the stator core are coaxially arranged. At least two stator teeth are correspondingly arranged on an inner side of the stator core, with coils wound around the stator teeth, and the coils are connected in series.

Referring to FIG. 9, the rotor core is provided with a permanent magnet 11, and at least one damper bar 13 is inserted through the rotor core in a predetermined region. The predetermined region is located between the permanent magnet 11 and an air gap, which is located between the stator core and the rotor core. The damper bar is configured to cut a magnetic field to generate a reaction force for suppressing a speed variation of the rotor. The main function of the damper bar is that when the single-phase permanent magnet motor operates by directly connecting to the grid, there is no controller, and the motor may experience speed divergence due to underdamping. Since the rotor speed is not synchronized with the synchronous speed, the damper bar will cut the magnetic field to generate resistance, increasing the damping effect and reducing the speed. Therefore, the defect of grid-connected speed divergence existing in the prior art when single-phase permanent magnet motors are directly powered by the grid is overcome.

In an alternative embodiment, referring to FIG. 6, end rings 14 are respectively arranged at the edges of the upper and lower surfaces of the rotor core. The damper bars are electrically connected via the end rings, and the permanent magnet is fixedly to the rotor core by the two end rings. The end rings connecting the rotor damper bars can serve as rotor pressure plates, thereby eliminating the material cost and tooling cost of the stainless steel rotor pressure plates used in conventional motor rotors.

In an alternative embodiment, the number of poles of the permanent magnet and the number of the damper bars are both even numbers, which may be two, four, or more.

In an alternative embodiment, a cross-sectional shape of the permanent magnet is any one of a tile shape, an in-line shape, and a V-shape.

In an alternative embodiment, a cross-section of the damper bar is circular or polygonal.

In an alternative embodiment, the material of the damper bar may include high-conductivity materials such as copper, aluminum, etc.

In an alternative embodiment, the predetermined region is located on an arc concentric with the rotor core.

By arranging damper bars in the rotor core, the present disclosure solves the problem of oscillation and divergence of grid-connected speed in single-phase permanent magnet motors, thus improving the operation stability of the system. The arrangement of damper bars can effectively suppress the possible non-convergence of grid-connected speed, thereby enabling the single-phase permanent magnet motor to realize grid-connected operation and improve its operation efficiency.

An exemplary embodiment of the present disclosure provides a household appliance, which comprises the single-phase permanent magnet motor according to the above embodiments. The household appliance may include a refrigerator, an air conditioner, a washing machine, etc.

By incorporating the single-phase permanent magnet motor of the above embodiments into the household appliance, the quality and operation stability of the household appliance can be improved.

Although the specific implementations of the present disclosure have been described above, those skilled in the art should understand that these are merely illustrative examples, and the protection scope of the present disclosure is defined by the appended claims. Those skilled in the art can make various changes and modifications to these implementations without departing from the principle and essence of the present disclosure, and such changes and modifications shall fall within the scope of the present disclosure.

1. A single-phase permanent magnet motor, comprising:
a rotor core and a stator core, wherein the rotor core and the stator core are coaxially arranged;
at least two stator teeth correspondingly arranged on an inner side of the stator core, with coils wound around the stator teeth and the coils being connected in series;
a starting slot provided at an end of a stator tooth away from a yoke, the starting slot being located on a side of the stator tooth opposite to a rotor rotation direction along a centerline of the stator tooth, wherein a central angle corresponding to an interval between an edge of the starting slot and an adjacent slot opening is less than a predetermined angle, and the slot opening is located between two adjacent stator teeth.

2. The single-phase permanent magnet motor of claim 1, wherein the rotor core is provided with a permanent magnet, and at least one damper bar is inserted through the rotor core in a predetermined region, the predetermined region being located between the permanent magnet and an air gap, wherein the air gap is located between the stator core and the rotor core, and the damper bar is configured to cut a magnetic field to generate a reaction force for suppressing a speed variation of the rotor.

3. The single-phase permanent magnet motor of claim 1, wherein each stator tooth, at its end remote from the yoke, extends circumferentially to both sides about the centerline of the stator tooth to form symmetric tooth shoes.

4. The single-phase permanent magnet motor of claim 1, wherein a sheet-shaped permanent magnet is inserted through the rotor core; and
a central angle corresponding to a width of a flux bridge on a side edge of the permanent magnet adjacent to the air gap is the predetermined angle.

5. The single-phase permanent magnet motor of claim 2, wherein each axial end face of the rotor core is respectively provided an end ring at an edge thereof, and
the damper bar is electrically connected via the end ring, and the permanent magnet is fixed in the rotor core by two end rings; and/or
a number of poles of the permanent magnet, a number of stator teeth, and a number of damper bars are all even numbers; and/or
a cross-section of the damper bar is circular or polygonal; and/or
a cross-sectional shape of the permanent magnet is any one of a tile shape, an in-line shape, and a V-shape; and/or
a material of the damper bar comprises copper and/or aluminum; and/or
the stator teeth are evenly distributed along a circumference of the stator core, and permanent magnets are evenly distributed along a circumference of the rotor core; and/or
the permanent magnet is magnetized by parallel magnetization or radial magnetization.

6. The single-phase permanent magnet motor of claim 2, wherein the predetermined region is located on an arc concentric with the rotor core.

7. The single-phase permanent magnet motor of claim 6, wherein endpoints of the arc are respectively connected to an end of the permanent magnet away from the starting slot and a first connecting line, wherein the first connecting line is a line connecting an endpoint of the starting slot, which is on a side edge of the starting slot closer to the centerline of the stator tooth and closer to the air gap, and a midpoint of the permanent magnet, when the centerline of the stator tooth coincides with a centerline of the permanent magnet, and wherein the midpoint is an intersection point of a contour line of the permanent magnet on a side close to the damper bar and the centerline of the permanent magnet; and/or
the predetermined region is an intersection point of the arc and a second connecting line, and the second connecting line is a line connecting an endpoint of a tooth shoe away from the starting slot and closer to the centerline of the stator tooth, and the midpoint of the permanent magnet, when centerline of the stator tooth coincides with the centerline of the permanent magnet, and wherein the midpoint is the intersection point of the contour line of the permanent magnet on the side close to the damper bar and the centerline of the permanent magnet.

8. A single-phase permanent magnet motor, comprising:
a rotor core and a stator core, wherein the rotor core and the stator core are coaxially arranged,
wherein at least two stator teeth correspondingly are arranged on an inner side of the stator core, coils are wound around the stator teeth, and the coils are connected in series; and
wherein the rotor core is provided with a permanent magnet, and at least one damper bar is inserted through the rotor core in a predetermined region, the predetermined region being located between the permanent magnet and an air gap, wherein the air gap is located between the stator core and the rotor core, and the damper bar is configured to cut a magnetic field to generate a reaction force for suppressing a speed variation of the rotor.

9. The single-phase permanent magnet motor of claim 8, wherein each axial end face of the rotor core is respectively provided an end ring at an edge thereof; and
the damper bar is electrically connected via the end ring, and the permanent magnet is fixedly connected to the rotor core by the two end rings; and/or
a number of poles of the permanent magnet and a number of damper bars are both even numbers; and/or
a cross-sectional shape of the permanent magnet is any one of a tile shape, an in-line shape, and a V-shape; and/or
a cross-section of the damper bar is circular or polygonal; and/or
a material of the damper bar comprises copper and/or aluminum; and/or
the predetermined region is located on an arc concentric with the rotor core.

10. A household appliance, comprising the single-phase permanent magnet motor of claim 1.

11. The household appliance of claim 10, wherein the rotor core is provided with a permanent magnet, and at least one damper bar is inserted through the rotor core in a predetermined region, the predetermined region being located between the permanent magnet and an air gap, wherein the air gap is located between the stator core and the rotor core, and the damper bar is configured to cut a magnetic field to generate a reaction force for suppressing a speed variation of the rotor.

12. The household appliance of claim 10, wherein each stator tooth, at its end remote from the yoke, extends circumferentially to both sides about the centerline of the stator tooth to form symmetric tooth shoes.

13. The household appliance of claim 10, wherein a sheet-shaped permanent magnet is inserted through the rotor core; and
a central angle corresponding to a width of a flux bridge on a side edge of the permanent magnet adjacent to the air gap is the predetermined angle.

14. The household appliance of claim 11, wherein each axial end face of the rotor core is respectively provided an end ring at an edge thereof, and
the damper bar is electrically connected via the end ring, and the permanent magnet is fixed in the rotor core by two end rings; and/or
a number of poles of the permanent magnet, a number of stator teeth, and a number of damper bars are all even numbers; and/or
a cross-section of the damper bar is circular or polygonal; and/or
a cross-sectional shape of the permanent magnet is any one of a tile shape, an in-line shape, and a V-shape; and/or
a material of the damper bar comprises copper and/or aluminum; and/or
the stator teeth are evenly distributed along a circumference of the stator core, and permanent magnets are evenly distributed along a circumference of the rotor core; and/or
the permanent magnet is magnetized by parallel magnetization or radial magnetization.

15. The household appliance of claim 11, wherein the predetermined region is located on an arc concentric with the rotor core.

16. The household appliance of claim 15, wherein endpoints of the arc are respectively connected to an end of the permanent magnet away from the starting slot and a first connecting line, wherein the first connecting line is a line connecting an endpoint of the starting slot, which is on a side edge of the starting slot closer to the centerline of the stator tooth and closer to the air gap, and a midpoint of the permanent magnet, when the centerline of the stator tooth coincides with a centerline of the permanent magnet, and wherein the midpoint is an intersection point of a contour line of the permanent magnet on a side close to the damper bar and the centerline of the permanent magnet; and/or
the predetermined region is an intersection point of the arc and a second connecting line, and the second connecting line is a line connecting an endpoint of a tooth shoe away from the starting slot and closer to the centerline of the stator tooth, and the midpoint of the permanent magnet, when centerline of the stator tooth coincides with the centerline of the permanent magnet, and wherein the midpoint is the intersection point of the contour line of the permanent magnet on the side close to the damper bar and the centerline of the permanent magnet.

17. A household appliance, comprising the single-phase permanent magnet motor of claim 8.

18. The household appliance of claim 17, wherein each axial end face of the rotor core is respectively provided an end ring at an edge thereof; and
the damper bar is electrically connected via the end ring, and the permanent magnet is fixedly connected to the rotor core by the two end rings; and/or
a number of poles of the permanent magnet and a number of damper bars are both even numbers; and/or
a cross-sectional shape of the permanent magnet is any one of a tile shape, an in-line shape, and a V-shape; and/or
a cross-section of the damper bar is circular or polygonal; and/or
a material of the damper bar comprises copper and/or aluminum; and/or
the predetermined region is located on an arc concentric with the rotor core.
